(19) United States
(12) Patent Application Publication
(10) Pub. No.: US 2002/0071917 A1
(43) Pub. Date: Jun. 13, 2002

(54) Process and device for treating articles in a dip bath

(76) Inventor: Emil Hepting, Bad Durrheim (DE)

Correspondence Address: Stephan A. Pendorf, Pendorf & Cutliff, P.O. Box 20445, Tampa, FL, 33622-0445, US

(21) Appl. No.: 10/012,854

(22) Filed: Dec. 10, 2001

(30) Foreign Application Priority Data
Dec. 8, 2000 (DE) 100 61 226.1

(51) Int. Cl. B05D 1/18

(52) U.S. Cl. 427/430.1; 118/404

(57) ABSTRACT

In order to provide an even protective layer on the outer surfaces of work pieces, in particular also on critical points, in a galvanizing tank (3), the so-called articles (2) are moved in the dip bath (3) not only in the horizontal but also in the vertical direction. In order to achieve a combined horizontal and vertical movement of the articles (2), a drive means in the device for horizontal movement is combined with a drive means for vertical movement. It is particularly advantageous to move the articles (2) in the horizontal direction along a hypocycloid (29).

### BACKGROUND OF THE INVENTION

### FIELD OF THE INVENTION

The invention concerns a process for treatment of articles in a dip bath, wherein the articles are moved in the dip bath along a horizontal plane.

The invention further concerns a device with a first drive means, in order to move articles provided on an article carrier along a horizontal plane in a dip bath.

Work pieces—the so-called articles or goods—are dipped in a galvanizing tank or paint bath, so that a protective layer is applied to their outer surface. In the case of a galvanizing tank the negative pole of a direct current source is connected to the article, which thus forms the cathode. In order to achieve an even application of the protective layer, an even concentration gradient should be established on the diffusion boundary layer of the cathode film. In order to apply over the entire outer surface of the work piece a protective layer with an even as possible layer thickness, the articles provided on a article carrier are moved along a horizontal plane in the dip bath. Depending upon their shape, the work pieces can have on their outer surface critical points such as for example cutbacks, corners, sharp edges and the like, upon which the protective layer is only insufficiently established despite the horizontal movement in the dip bath.

### SUMMARY OF THE INVENTION

It is thus the task of the invention to design a process and a device for treatment of articles in a dip bath, such that a protective layer is established with great uniformity over the entire outer surface of the articles, in particular also the critical points.

In accordance with the invention this task is solved thereby, that the articles are moved—in addition to the movement in the horizontal plane—also in the vertical direction in the dip bath.

With respect to the apparatus, this task is solved thereby, that in addition to the first drive means, which moves the articles in the horizontal direction in the dip bath, a second drive means is provided, which moves the articles in the vertical direction in the dip bath.

By these inventive means for moving the articles in a galvanizing or paint bath not only horizontally but rather also vertically, an even reaction results at all points of the outer surface of the article. As further advantages of the invention it can be mentioned that the bath is optimally utilized, such that an even degree of deposition and an even galvanizing or application of paint to the outer surface is achieved.

The articles are moved in the horizontal direction along a circle or an ellipse. It is particularly advantageous to move the articles along a hypocycloid. During a complete cycle of the horizontal movement, for example at least one complete stroke cycle in the vertical direction is carried out. Preferably the stroke length for the vertical movement is adjustable.

The inventive device includes a first drive means for moving the articles, which are provided on an article carrier, in the horizontal direction in the dip bath. Additionally a second drive means is provided, which moves the articles in the vertical direction in the dip bath.

The first and the second drive means are essentially comprised of a horizontal drive shaft, upon which two eccentrics (gears) are seated. The horizontal drive shaft drives a first and a second vertical drive shaft. For example, seated on the horizontal drive shaft are a first and a second bevel gear. The first bevel gear of the horizontal drive shaft engages in a bevel which is secured or connected to the lower end of the first vertical drive shaft, while the second bevel gear of the horizontal drive shaft engages in a bevel gear which is secured to the lower end of the vertical shaft. On each vertical drive shaft a rotor with one arm is secured fixed against rotation yet slideable in the vertical direction. Each rotor rests on a cam or carrier plate. The first cam is driven by a first eccentric gear and the second cam is driven by a second eccentric gear of the horizontal drive shaft. The article carrier with the articles is rotatably mounted on the arms of the rotor.

By rotation of the horizontal drive shaft, for example by means of an electric motor, the vertical drive shafts are rotated, so that the arms of the rotor carry out a circular movement. The article carrier with the articles thus also carries out a circular movement, so that the articles are turned in the dip bath to describe a circle. At the same time the eccentric gears move the two rotors back and forth in the vertical direction, so that the article carrier with the articles carries out a stroke movement.

A design of the inventive device envisions that the arm of each rotor is mounted in a planetary gear which rolls along the inner circumference or the outer circumference of a sun gear. The sun gear can be provided fixed against rotation or can be rotated. On the planetary gears there is secured respectively one arm, upon which the article carrier with the articles is secured. Upon driving of the horizontal drive shaft the vertical drive shafts rotate, whereby the planetary gears roll on the inner circumference of the two sun gears. The end of the arm on each planetary wheel thus moves along a hypocycloid. The article carrier with the articles carries out the same movement. The articles are thus moved in the horizontal direction along a hypocycloid. At the same time the articles are moved by means of the eccentric gear back and forth in the vertical direction in the dip bath.

### BRIEF DESCRIPTION OF THE DRAWINGS

The invention will be described and explained on the basis of a first and second illustrative embodiment represented in the figures.

In the figures there is shown:

FIG. 1 a first illustrative embodiment of the inventive device,

FIG. 2 a second illustrative embodiment of the inventive device,

FIG. 3 a movement path of a planetary gear of the second embodiment in top view,

FIG. 4 a dip bath with the second illustrative embodiment in exposed or cut away view, and

FIG. 5 the dip bath with the second embodiment in top view.

### DETAILED DESCRIPTION OF THE INVENTION

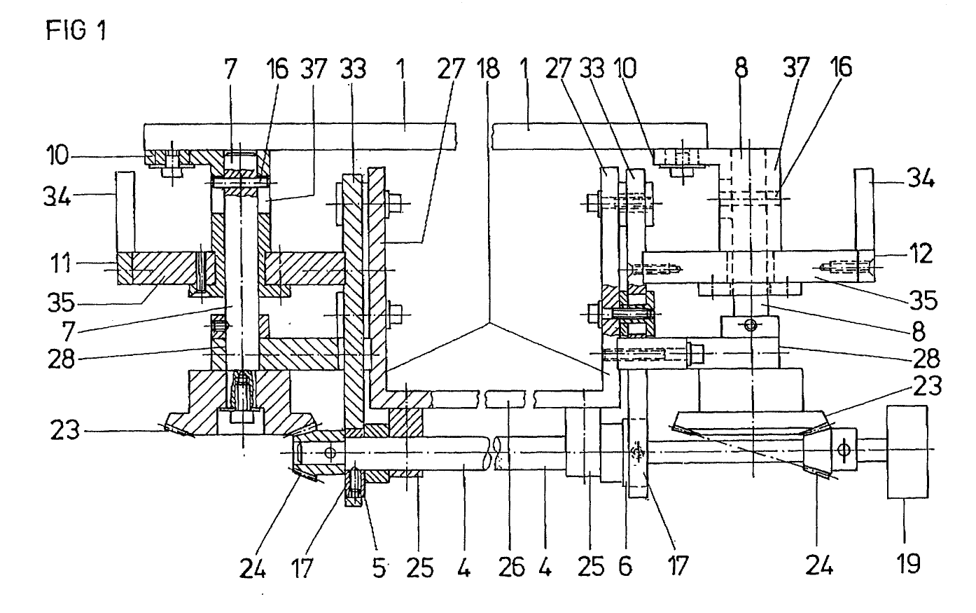

FIG. 1 shows a first illustrative embodiment of an inventive device in cut-away view.

FIG. 1 shows a first embodiment of an inventive device in exposed view. The horizontal drive shaft 4 is mounted on two bearings 25, which are provided on the crosspiece 26 of a U-shaped mounting block 18. On the right and on the left shank 27 of the U-shaped mounting block 18 there is secured respectively one lifter 11 or, as the case may be, 12 slideable in the vertical direction. The lifters 11 and 12 are designed to be U-shaped, comprised of one crosspiece 35 and two shanks 33 and 34, wherein the shank 33 is made longer than the shank 34. On the lower end of the longer shank a sliding block or link 17 is provided, in which an eccentric is mounted. In the sliding block 17 of the longer shank 33 of the lifter 11 an eccentric 5 is mounted on the horizontal drive shaft 4, while in the sliding block 17 of the longer shank 33 of the lifter 12 an eccentric 6 seated upon the horizontal drive shaft 4 is mounted. On the right and the left shaft 27 of the U-shaped mounting block 18 there is provided respectively one first mount 28 for respectively one vertical drive shaft 7 and 8. A second mount or bearing 36 for the vertical drive shafts 7 and 8 is provided in the crosspieces 35 of the U-shaped lifter 11 and 12. On the upper end of the vertical drive shaft 7 and 8 there is seated a driver or rotor 9, which lies upon the crosspiece 35 of the lifter 11 and 12. The rotor 9 is slideable in the vertical direction but connected fixed against rotation with the respective drive shaft 7 and 8. For this a longitudinal borehole 37 is introduced in the rotor 9, in which a drive pin 16 engages stuck in the vertical drive shaft 7 and 8. On the upper end of the rotor 9 an arm 10 is provided, upon which the article carrier 1 is mounted fixed against rotation. On the lower end of the vertical drive shaft 7 and 8 there is seated respectively one bevel gear 23, which engage respectively in one of the bevel gears 24 seated on the horizontal drive shaft 4. The one bevel gear 24 is secured to the left end of the horizontal drive shaft 4, while the other bevel gear 24 is provided at the right end of the horizontal drive shaft 4. The U-shaped mounting block 18, which carries the entire drive means as well as the article carrier, is secured at the appropriate point to a basin or a tub. For example, the U-shaped mounting block can be secured to the upper rim of the basin or the tub, in which a galvanizing composition or a paint bath is located.

The articles to be provided with the protective layer are situated for example in article baskets hanging from the article carrier 1 or are hangingly secured directly to the article carrier 1, whereupon they are dipped into the dip bath.

The horizontal drive shaft 4 can be connected for example with the drive shaft of an electric motor 19, of which the rotational speed can be for example controlled or regulated. Since the eccentrics 5 and 6 seated on the horizontal drive shaft 4 likewise rotate, the lifters 11 and 12 are moved up and down vertically, which also moves the two accompanying rotors 9 likewise up and down. Since the article carrier 1 is rotatably mounted on the arms 10 of the rotor 9, it is likewise moved up and down. The movement downwards is positively controlled by the sliding block 17. The articles hanging on the article carrier 1 are therewith moved up and down in the dip bath.

The bevel gears 23 secured to the lower end of the vertical drive shafts 7 and 8 are driven via the bevel gears 24 seated on the horizontal drive shaft 4, so that the vertical drive shafts 7 and 8 likewise rotate. By means of the drive pins 16, which are inserted to be guided in the longitudinal boreholes 37 of the rotors 9, the rotors 9 rotate along with the vertical drive shafts 7 and 8. The mounting point of the article carrier 1 on the arm 10 of the two rotors 9 thus describes a circular movement path, which the articles secured to the article carrier also describe.

The articles hanging in the dip bath thus describe, simultaneously with the horizontal circular motion, a vertical linear up and down movement, whereby already a nearly optimal evenness of the protective layer is produced.

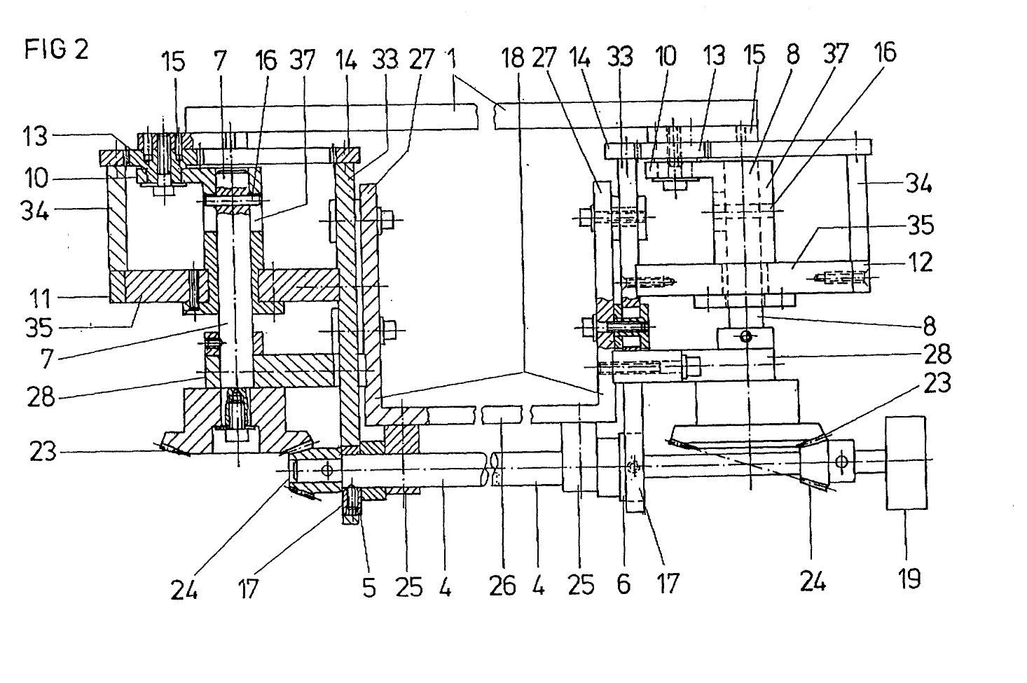

In FIG. 2 a second embodiment of an inventive device is shown in partial cut-away.

The second embodiment differs from the first in that on the arms 10 of the rotor 9, in place of the article carrier, respectively one planetary gear 13 is rotatably mounted. On the upper end of the two lifters 11 and 12 there is secured an internally geared sun gear 14, on the inner circumference of which the planetary gear 13 rolls. Alternatively to this, the externally geared planetary gear can also roll on the outer circumference of an externally geared sun gear. On the planetary gear 13 an arm 15 is secured, upon which the article carrier 1 is rotatably mounted.

The vertical upward and downward movement occurs just as in the first embodiment. The eccentrics 5 and 6 move the lifters 11 and 12 up and down, which take along the rotors 9 with the planetary gears 13, upon which the article carriers are rotatably mounted. The article carrier 1 with the thereupon secured articles thus describes the same upward movement as the first embodiment.

In the horizontal plane the rotors 9 describe as in the first embodiment a circular shaped movement, whereby the planetary gears 13 roll on the inner circumference of the two internally geared sun gears 14. The arm 15 of the planetary gears 13 thus moves along a hypocycloid, and therewith also the article carrier 1 with the articles. The articles are thus moved in the dip bath in the horizontal direction along a hypocycloid, while they make at the same time a vertical up and down movement.

It has been discovered that the combination of a horizontal movement along a hypocycloid with a vertical up and downward movement is optimal for development of an even protective layer—in particular also on the critical points—upon the outer surface of the article to be treated.

Just as in the first embodiment, the second embodiment is secured to a suitable point on a basin or a tub.

Just as the first, so also the second embodiment of the inventive device can be so designed, that the stroke of the vertical movement is adjustable. Preferably the horizontal and the vertical movement are so combined with each other, that during the carrying out of a complete cycle of the horizontal movement at least one complete stroke in the vertical direction is carried out.

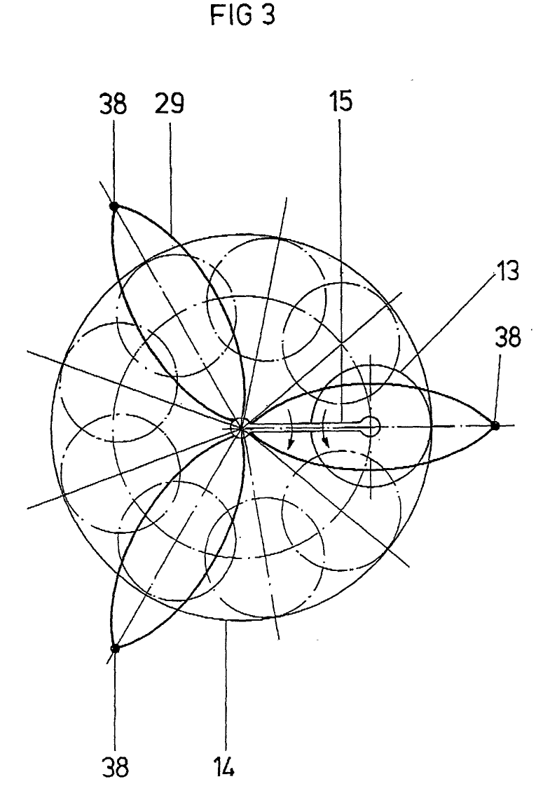

In FIG. 3 there is shown one sun gear 14 with one planet gear 13 and the arm 15 as well as the described hypocycloid 29.

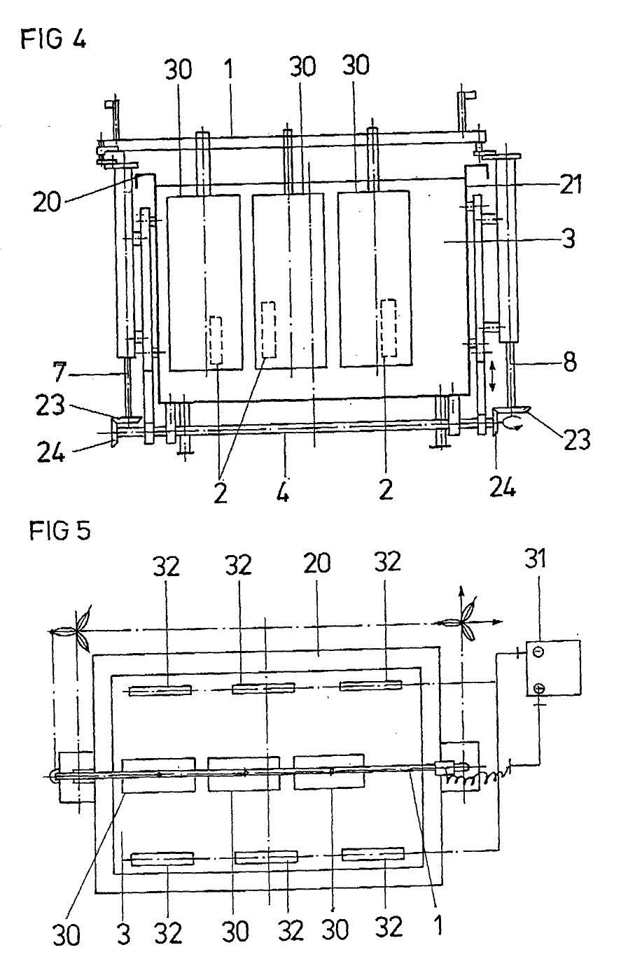

In FIG. 4 a dip bath 21 with the thereupon secured inventive device is shown in exposed view. The dip bath 21 is filled with an electrolyte 22, in which the article baskets 30, in which the articles 2 to be galvanized are located, which are shown in dashed lines in FIG. 4, are dipped. The article baskets 30 hang on the article carrier 1 which moves up and down in the vertical direction as well as in the horizontal direction along a hypocycloid. The article carrier 1 is located above the dip bath 21.

In FIG. 5 the dip bath 21 with the inventive device is shown in top view. The negative pole of a direct current source 31 is connected with the article carrier 1, which is connected electrically conductively with the article basket 30 and the therein situated articles 2, which represent the cathode. Between the article carrier 1 positioned in the middle of the dip bath 21 and the right and left bath walls 20 is an anode rail 32. The ions flow between the anode rail 32 and the cathode.

As already described, the inventive process and the inventive device are particularly suitable for galvanizing or painting of work pieces, the so-called articles. Besides the superior quality of the protective layer, an optimal utilization of the dip bath is achieved.

Reference Number List

1 Article carrier

2 Article

3 Dip bath

4 Horizontal drive shaft

5 Eccentric gear

6 Eccentric gear

7 Vertical drive shaft

8 Vertical drive shaft

9 Rotor

10 Arm of the rotor

11 Lifter

12 Lifter

13 Planetary gear

14 Sun gear

15 Arm of the planet gear

16 Drive pin

17 End block in the long shank

18 Mounting block

19 Electric motor

20 Basin rim

21 Dip bath

22 Electrolyte

23 Bevel gear of the vertical drive shaft

24 Bevel gear of the horizontal drive shaft

25 Mount or bearing at the crosspiece 26 of the mounting block 18

26 Crosspiece of the mounting block 18

27 Shanks of the mounting block

28 First mount or bear for vertical drive shaft at shank 27

29 Hypocycloid

30 Article basket

31 Direct current source

32 Anodic rail

33 Long shanks of a lifter

34 Short shank of a lifter

35 Crosspiece of a lifter

36 Second mount or bearing for the vertical drive in the crosspiece 35

37 Longitudinal borehole in the rotor

38 Reversal point of a hypocycloid

What is claimed is:

1. A process for treatment of articles (2) in a dip bath (3) comprising moving the articles (2) in a horizontal plane in the dip bath (3), and additionally moving the articles (2) in the vertical direction in the dip bath (3).

2. A process according to claim 1, wherein the articles (2) are attached to an article carrier (1).

3. A process according to claim 1 or 2, wherein the articles (2) are cyclically moved in the horizontal direction along a circle or an ellipse.

4. A process according to claim 1 or 2, wherein the articles (2) are moved in a horizontal direction cyclically along a hypocycloid (29).

5. A process according to claim 1, 2, 3 or 4, wherein the stroke of the vertical movement is adjustable.

6. A process according to one of the preceding claims, wherein during a complete cycle of the horizontal movement at least one complete stroke movement in the vertical direction is carried out.

7. A device with a first drive means, with which articles (2) provided on an article carrier (1) are moved in a horizontal plane in a dip bath (3), further including a second drive means, which further moves the articles (2) in the vertical direction in the dip bath (3).

8. A device according to claim 7, wherein:
a first eccentric (5) and a second eccentric (6) are seated on a horizontal drive shaft (4),
a first and a second vertical drive shaft (7, 8) are driven by the horizontal drive shaft (4), upon which vertical drive shafts respectively one rotor (9) with an arm (10) is mounted fixed against rotation however slideable in the vertical direction,
the rotor (9) lies upon one lifter (11, 12), the first lifter (11) is driven by a first eccentric (5) and the second lifter (12) is driven by a second eccentric (6), and the article carrier (1) with the articles (2) is mounted fixed against rotation on the arms (10) of the rotors (9).

9. A device according to claim 7, wherein:
a first and a second eccentric (5, 6) are seated on a horizontal drive shaft (4),
from the horizontal drive shaft (4) a first and second vertical drive shaft (7, 8) are driven, upon which respectively one rotor (9) with a first arm (10) is secured fixed against rotation however slideable in the vertical direction,
the rotor (9) lies upon respectively one lifter (11, 12),
the first lifter (11) is driven by a first eccentric (5) and the second lifter (12) is driven by a second eccentric (6),
on the first arm (12) of each rotor (9) respectively one planetary gear (13) is rotatably mounted, which can roll on the inner circumference or on the outer circumference of a sun gear (14) secured on the lifter (11, 12), and
on the planetary gears (13) there is respectively provided one second arm (15), upon which the article carrier (1) is rotatably mounted.

10. A device according to claim 9, wherein the sun gear (14) is internally geared, while the planetary gears (13) are externally geared.

11. A device according to claim 9, wherein the planetary gears (13) and the sun gear (14) are externally geared.

12. A device according to claim 9, 10 or 11, wherein the sun gear (14) is provided fixed against rotation.

13. A device according to claim 7, 8, 9, 10, 11 or 12, wherein a drive pin (16) of the vertical drive shaft (7, 8) is in engagement with a longitudinal borehole (37) of the tubular or pipe shaped rotor (9).

14. A device according to one of claims 7 through 13, wherein the lifter (11, 12) is secured on the mounting block (18) to be slideable in the vertical direction, on which mounting block (18) the horizontal drive shaft (4) is mounted.

15. A device according to one of claims 7 through 14, wherein the horizontal drive shaft (4) is driven by an electric motor (19).

16. A device according to claim 15, wherein the rotational speed of the electric motor is controllable or regulated.

17. A device according to one of claims 8 through 16, wherein two bevel gears (24) are seated on the horizontal drive shaft (4), which respectively engage in a bevel gear (23) seated on the lower end of the vertical drive shafts (7, 8).

18. A device according to one of claims 14 through 17, wherein the mounting block (18) is secured to a dip bath (21) filled with a liquid medium (22), in which the articles (2) can be dipped as well as be moved in the horizontal as well as the vertical direction.

19. A device according to one of claims 8 through 18, wherein the lifters (11, 12) are designed U-shaped with a lifter crosspiece (35) and two lifter shanks (33, 34), wherein one of the two lifter shanks (33) is made longer, wherein a sliding block (17) is provided in the longer shank (33), in which the eccentrics (5, 6) are mounted, and wherein the rotors (9) lie upon the lifter crosspiece (35).

20. Process or device according to one of the preceding claims, wherein the dip bath (3) is a galvanizing tank or paint bath.
